(19) United States
(12) Patent Application Publication
(10) Pub. No.: US 2020/0372278 A1
(43) Pub. Date: Nov. 26, 2020

(54) Handwriting Recognition for Receipt

(71) Applicants: Canon Information and Imaging Solutions, Inc., Melville, NY (US); Canon U.S.A., Inc., Melville, NY (US)

(72) Inventors: Ryoji Iwamura, Port Washington, NY (US); Shingo Murata, Mineola, NY (US); Kazuaki Fujita, Tokyo (JP); Kenji Takahama, Tokyo (JP)

(21) Appl. No.: 16/881,769

(22) Filed: May 22, 2020

Related U.S. Application Data
(60) Provisional application No. 62/852,756, filed on May 24, 2019.

(51) Int. Cl. G06K 9/20; G06K 9/03; G06K 9/46; G06K 9/38

(52) U.S. Cl. CPC G06K 9/2054; G06K 9/03; G06K 2209/01; G06K 9/38; G06K 9/4652; G06K 9/46

(57) ABSTRACT

An information processing method and apparatus are provided that performs operations including identifying, from an image obtained via an image capture device, at least one character string that is relevant in identifying information to be extracted from the image; defining an area, within the image, that includes information as an information extraction area, the information including a plurality of information elements; selecting a region within the defined area where the information to be extracted is expected to be present using a feature within the defined area; removing the feature from the selected region and correcting one or more errors associated with the information caused by the removal of the feature and extracting one or more alphanumeric characters from the corrected information, wherein the extracted one or more alphanumeric characters correspond to the elements of the information and are associated with a respective one of the at least one character strings.

### CROSS REFERENCE TO RELATED APPLICATIONS

This nonprovisional patent application claims the benefit of priority from U.S. Provisional Patent Application Ser. No. 62/852,756 filed on May 24, 2019, the entirety of which is incorporated herein by reference.

### BACKGROUND

### Field

The present disclosure relates generally to processing and analysis of a captured image.

### Description of Related Art

Applications exist that enable image capturing of a physical document. An example of this type of application is a receipt capture application that captures an image corresponding to a physical receipt such as one received when a purchase has been made by a user. It is desirable for users to be able to capture and analyze physical receipts in order to track costs and expenses attributable to the user. Additionally, many captured receipts include areas where users have written in values and it is also desirable to obtain information corresponding to written values on a receipt.

Many receipts have handwriting area such as a tip and total amount, but conventional OCR usually cannot read, with accuracy, the information contained in a handwriting area of the receipt. The handwriting area may include information such as value representing tip amount and total bill amount. Conventional OCR technology has difficulty reading the information in the handwriting area that was manually entered by a person unless the text is very clearly and appears as if it were printed text. While certain handwriting specialized recognition methods exist, those solutions expect the handwriting image to be pre-identified and to be provided in a certain condition. Thus, while general receipt capture application exist, a drawback associated with these application is that while they may retrieve printed texts, they cannot analyze the receipt properly in case a relevant value is a handwritten value such as tip amount and/or handwritten total amount.

### SUMMARY

According to aspect of the disclosure, an information processing method and apparatus are provided that performs operations including identifying, from an image obtained via an image capture device, at least one character string that is relevant in identifying information to be extracted from the image; defining an area, within the image, that includes information as an information extraction area, the information including a plurality of information elements; selecting a region within the defined area where the information to be extracted is expected to be present using a feature within the defined area; removing the feature from the selected region and correcting one or more errors associated with the information caused by the removal of the feature and extracting one or more alphanumeric characters from the corrected information, wherein the extracted one or more alphanumeric characters correspond to the elements of the information and are associated with a respective one of the at least one character strings.

These and other objects, features, and advantages of the present disclosure will become apparent upon reading the following detailed description of exemplary embodiments of the present disclosure, when taken in conjunction with the appended drawings, and provided claims.

### BRIEF DESCRIPTION OF THE DRAWINGS

FIG. 1 is flow diagram detailing an image processing and analysis algorithm.

FIG. 2 represents an exemplary image captured by an image capture device.

FIG. 3 illustrates exemplary image processing performed on a captured image.

FIG. 4 illustrates exemplary image processing performed on a captured image.

FIG. 5 illustrates exemplary image processing performed on a captured image.

FIG. 6 illustrates exemplary image processing performed on a captured image.

FIGS. 7A & 7B represent exemplary image processing performed on a captured image.

FIG. 8 illustrates exemplary image processing performed on a captured image.

FIG. 9 illustrates exemplary image processing performed on a captured image.

FIG. 10 illustrates exemplary image processing performed on a captured image.

FIG. 11 illustrates exemplary image processing performed on a captured image.

FIG. 12 is a block diagram detailing hardware for performing the image processing and analysis algorithm.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DESCRIPTION OF THE EMBODIMENTS

Exemplary embodiments of the present disclosure will be described in detail below with reference to the accompanying drawings. It is to be noted that the following exemplary embodiment is merely one example for implementing the present disclosure and can be appropriately modified or changed depending on individual constructions and various conditions of apparatuses to which the present disclosure is applied. Thus, the present disclosure is in no way limited to the following exemplary embodiment and, according to the Figures and embodiments described below, embodiments described can be applied/performed in situations other than the situations described below as examples. Further, where more than one embodiment is described, each embodiment can be combined with one another unless explicitly stated otherwise. This includes the ability to substitute various steps and functionality between embodiments as one skilled in the art would see fit.

There is a need to provide a system and method that improves the ability properly identify non-computerized information within an image such that a value of that information may be extracted from the image with a high degree of reliability. The application according to the present disclosure resolves a problem related to the extraction of data by properly identifying an area of an image where non-computerized text is present and enhancing the area of that image such that the values of the non-computerized text can more easily be extracted. For example, in the application according to the present disclosure can anticipate a location within an image where handwritten text is expected to be and performs image enhancement processing to ensure that the value of the handwritten text is capable of being extracted with a high degree of reliability. More specifically, the present application enables extraction of handwritten text no matter the size, style or other variations on handwriting that commonly exist between people. Based on the advantageous differentiation, the application improves the reliability and accuracy for any data extraction processing to be performed on the target object(s) in the captured image.

The applications and the advantages provided thereby can be achieved based on the algorithm and figures discussed hereinbelow.

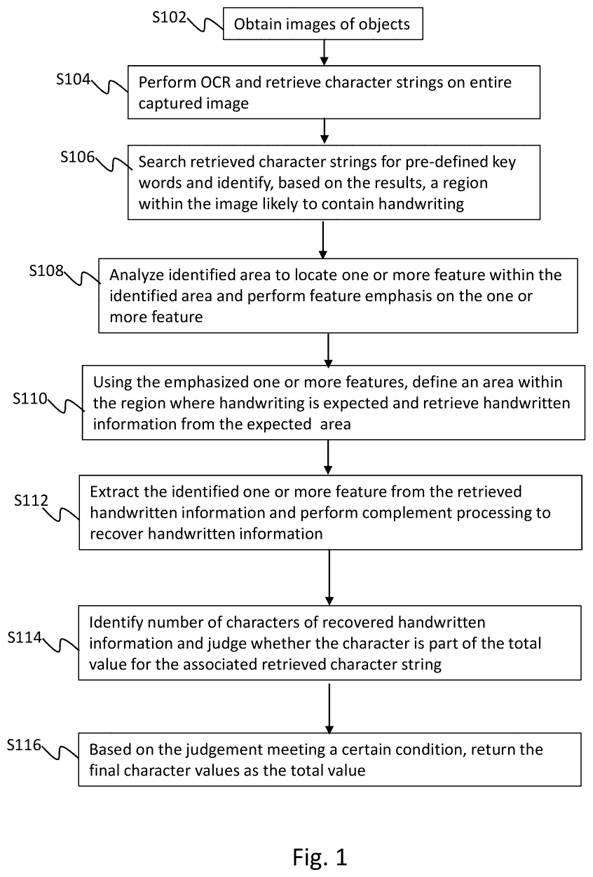

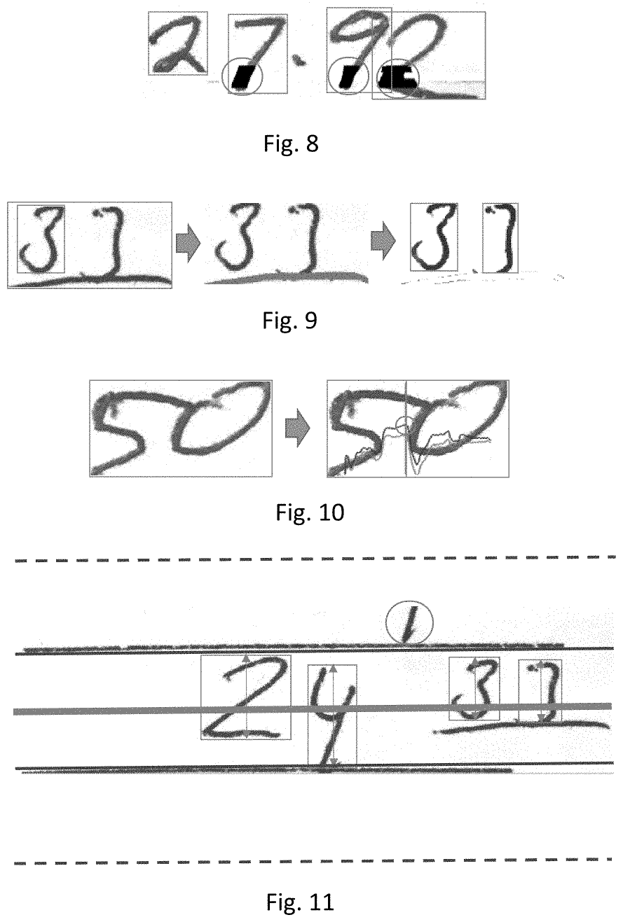

FIG. 1 illustrates an exemplary image processing and analysis algorithm executed by an information processing apparatus. The algorithm is embodied as a set of instructions stored in one or more non-transitory memory devices that are executable by one or more processors (e.g. CPU) to perform the functions that are described in the present disclosure. In one embodiment information processing apparatus such as a computing device is provided. A computing device includes but is not limited to a personal computer or server stores the instructions which, when executed, configure the one or more processors to perform the described functions. In another embodiment, the device on which the algorithm executes is a portable computing device such as a mobile phone, smartphone, tablet or the like. Further description of exemplary hardware that is responsible for the functionality described herein can be found in FIG. 10 which is discussed in greater detail below.

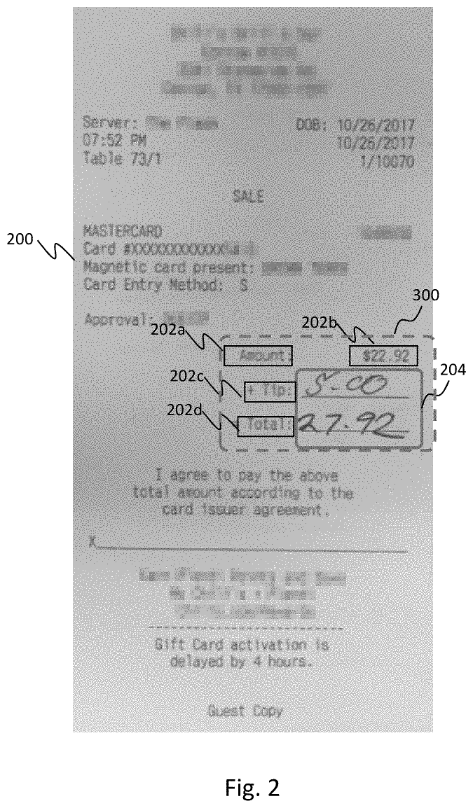

The following description of the functionality of image processing and analysis application according to the present disclosure will occur using the instructional steps illustrated in FIG. 1 while making reference to exemplary images and image processing operations performed on captured images illustrated in FIGS. 2-11.

At step S102, images of one or more objects are obtained. The images are obtained using an image capture device such as a camera of a mobile phone. The images include at least one object and includes one or more data items that can identified and extracted for storage in a data store (e.g. database). In another embodiment, the images may be obtained via file transfer process whereby the computing device acquires one or more images from an external source. This may include, for example, a cloud storage apparatus whereby a user can selectively access and download one or more images on which the processing disclosed herein may be performed. In another embodiment, the images may be attached to an electronic mail message and extracted by the application therefrom in order to perform the processing described herein.

An example of a type of image obtained at S102 is illustrated in FIG. 2. FIG. 2 depicts a printed object that memorializes an occurrence and which includes one or more sections thereof which allow a user to manually add additional information to the printed object. At times, it is desirable to identify and extract information from the printed object including the manually added information for purposes of tracking occurrences. This manually added information is generally handwritten using one of any number of writing instruments resulting in many variations in how the manually added information appears on the printed object making it difficult to extract. An example of the printed object as shown in FIG. 2 is a receipt commonly received at a restaurant whereby a person is able to manually add a value for one or more portions on the receipt including an amount for tip and a total amount reflecting the manually added tip. At times it is necessary to track these amounts for various purposes and applications exist for doing so. However, there is particular difficulty in successfully and accurately being able to extract the handwritten information manually added to the printed object due to the variation in instruments used to add the information (e.g. pen, pencil, etc.) and associated writing style of the person manually adding the information. The following algorithm resolves this problem as set forth below.

At step S104, the obtained images are processed using optical character recognition processing module/process to retrieve character strings and location data associated with each retrieved character string. The results of the OCR in general will include all retrieved character strings and its location data within the image. The OCR processing performed may be able to recognize any type of alphanumeric character including, letter, numbers, special characters and can recognize characters of one or more language. As long as the result contains all retrieved character strings and its location data, the OCR module/process can be replaced with any general OCR module/process, but the quality of result will vary depending on the result of the OCR module/process.

The results of the OCR processing in S104 are illustrated in FIG. 2 which visualizes the results of the OCR processing. The result of the OCR processing creates character string fields, generally referred to by reference numeral 202, that surround each set of character strings recognized during the OCR processing. Each character string field 202 includes a range of characters recognized by the OCR processing performed. During the OCR processing in S104, the entire image is processed and as many character string fields 202 as there are recognizable text may be created. For the purposes of this description and the operation of the handwriting recognition application, only a subset of character string fields 202 are depicted in FIG. 2. As shown in FIG. 2, first through fourth character string fields 202a-202d, respectively, are visualized.

In step S106, a search is performed on all of the character string fields 202 generated in S104 to determine if the recognized characters in the respective fields 202 match one or more pre-defined relevancy conditions stored in a data store. The set of pre-defined relevancy conditions may be stored in tabular format or in a data store such as a database. The set of pre-defined relevancy conditions may include any or all of (a) one or more words or terms, (b) one or more particular characters, (c) format of characters within a field, and/or (d) relative location of fields to one or more other fields. In one embodiment, the pre-defined conditions include one or more word that elicits a user to manually input (e.g. handwrite) additional information in an area proximate to the one or more words on the object that was captured and obtained in S102. In the exemplary embodiment shown in FIG. 2, the set of or more pre-defined words include words that trigger a user to manually handwrite one or more numbers adjacent to the one or more pre-defined words. In one embodiment, the one or more pre-defined words include but are not limited to “Amount”, “Tip” and “Total” as these words suggest that an individual will manually input additional information in the form of numbers. In another embodiment, the search in S106 also compares characters in each retrieved character field to determine if the one or more characters in the respective field match a pre-defined format. For example, the pre-defined format may include a particular type of character followed by one or more numbers, a second different particular type of character followed by one or more other numbers. This exemplary format may be “S22.92” where the first particular type of character is “ ” and the second different particular type of character is “.” where one or more numbers are between the first and second particular type of character and one or more numbers follow the second particular type of character. In a further embodiment, the search in S106 identifies the relevant character string fields 202 by not only determining if characters within each field match pre-defined words but also, determines relevancy by using the location data associated with each respective character string field to determine relative location of the recognized character string fields 202 to each other. For example, the pre-defined words included the term “Amount” and any field that included a particular character such as “$”, the search would use the location of each of those fields to make a relevancy determination if those fields were within a lateral predetermined distance within the image from one another. In another example, if the pre-defined words are “Tip” and “Total”, the relevancy determination will use the location information associated with each character string field to determine if they are within a predetermined vertical distance from one another in the captured image.

In the example illustrated in FIG. 2, the captured image 200 represents a receipt from a restaurant where a user is expected to handwrite information representing a tip for services performed and handwrite a total that includes the amount for services plus the amount handwritten tip amount. The goal of the handwriting recognition algorithm described herein is to properly extract the relevant handwritten values as being associated with one or more recognized by the OCR processing. During S104, the OCR processing is preformed and a plurality of character string fields are recognized. During S104, every recognized character string field is compared to the pre-defined relevancy conditions such as those discussed above and the result of S106 returns first through fourth character string fields as relevant. The first character string field 202a includes the word “Amount”. The second character string field 202b which includes a particular character “ ” and/or a particular format for the characters “$22.92”. The third character string field 202c includes the word “Tip” and the fourth character string field 202d includes the word “Total”.

Upon determining the presence of one or more relevant character string fields as discussed above, the algorithm uses location information associated with the determined one or more relevant character string fields to identify a candidate recognition region within the image. The candidate recognition region is a region in the image that, based on the relevant character string fields, is likely or expected to contain handwritten information subject to extraction therefrom. The algorithm identifies the candidate recognition region based on one or more region selection conditions. The region selection conditions may include a predetermined area in the image relative to one or more of the character string fields 202 that meet pre-defined relevancy conditions. In one embodiment, the region selection condition causes selection of an area of the image that is adjacent to two character string fields that meet relevancy conditions. For example, the region selection condition is an area to the right of the third and fourth character string field 202c and 202d which set forth the relevancy conditions of “Tip” and “Total”. In another embodiment, the region selection condition causes selection of an area that is beneath a character string field meeting a relevancy condition when that character recognition field is adjacent to a further character string field that meets the same or another different relevancy condition.

As shown in FIG. 2, the algorithm determines that, in view of the first through fourth character string fields 202a-202d meeting one or more pre-defined relevancy conditions by having words/terms that match and/or are located relative to one another, S106 selects the candidate recognition region 204 as an area that is in a rightward direction from the third and fourth character string fields 202c and 202d, respectively, and downward direction from the second characters string field 202b in view of its adjacency to the first character string field 202a. The selection conditions described as being used to select the candidate recognition region 204 are merely exemplary and any type of condition that allows for definition of a particular area of an image based on a location of certain character strings may be used.

In one embodiment, a size of the candidate recognition region is also based on the location and position of the respective character string fields deemed to be relevant. For example, as shown herein, the algorithm knows the position of the upper bound of the third character string field 202c and the lower bound of the fourth character string field 202d and may use a distance between those boundaries as a height, in pixels, for the candidate recognition region 204. In another embodiment, the height in pixels may be automatically expanded a predetermined number of pixels in order to define an area having a height that is larger than the known distance to potentially capture more handwritten information. Further, the algorithm knows the location of the right boundary of both the third and fourth character string fields 202c and 202d and a rightward boundary of the second character string field 202b and may use a distance therebetween as a width, in pixels, of the candidate recognition region 204. In another embodiment, the width in pixels may be automatically expanded a predetermined number of pixels in one or a right and/or left direction order to define an area having a width that is larger than the known distance to potentially capture more handwritten information.

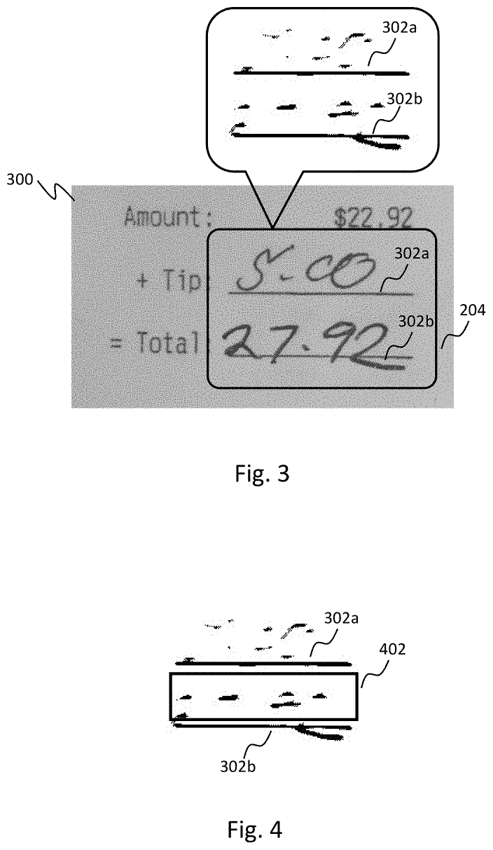

Once the candidate recognition area is defined, the algorithm, in step S108, analyzes pixel data within the candidate recognition region to be able to recognize handwritten information contained therein. In order to achieve this, the algorithm analyzes the image to determine if one or more image features are present therein which can then be emphasized by further image processing to better locate the handwritten information and, in step S110, using the emphasis applied to the one or more feature, set one or more sub-areas where handwritten information is expected and retrieve image data from within the one or more sub-regions as part of hand writing recognition. The processing performed in S108 and S110 will now be described with respect to FIGS. 3-5.

FIG. 3 illustrates the area of the obtained image encapsulated by the dashed line 300 of FIG. 2. This enlargement is provided for explanatory purposes and may or may not actually include an enlargement operation performed by the algorithm. FIG. 3 shows the candidate recognition region 204 selected in S106. The image data within region 204 is analyzed to determine the presence of one or more features therein. In the embodiment shown herein, the one or more features include one or two horizontal lines extending laterally across the region 204. Each of these horizontal lines represent a line on which handwritten information is located. Feature emphasis is performed on the identified one or more features as shown in the expanded region in FIG. 3. Feature emphasis processing is performed over the entire area 204 and is done based on the feature that is intended for detection and emphasis. In this case, the feature to be detected is a horizontal line. As such, any area within region 204 that includes a horizontal line of any length is emphasized by expanding an area of the detected horizontal line. Because the desired feature is a horizontal lines, in the vertical direction across area 204, all vertical lines are de-emphasized such that the color of the area around the lines determined to be vertical are closed resulting in a previously black vertical line to now appear white. It is due to this emphasis operation associated with the desired feature that the cutout area 204 shown in FIG. 3 (and also in FIG. 4 and elsewhere), that the horizontal lines where Tip and Total Amount values are handwritten are clear yet there still appears to be some of the handwritten information leftover in the spaces between. The leftover handwritten information appears as such because those areas of the handwritten information were determined to have information extending in a horizontal direction while most other handwritten information appears white because the emphasis processing determined those other portions of handwritten information extended in a vertical direction. After emphasis processing on the identified one or more features 302a and 302b (e.g. horizontal lines), at least one sub-area 402 is defined as a position where the handwritten text is located. In a case that the first horizontal line 302a and second horizontal line 302b are detected, define the area 402 between those lines as indicated by the border 402 as an area that includes handwritten information corresponding to the character string field adjacent thereto. In one embodiment the upper bound of area 402 is a predetermined distance from the first detected feature 302a and a predetermined distance above the second detected feature 302b. In this example, the handwritten information in area 402 represents a Total Amount. In the case where only the first feature 302a is present indicating only one horizontal line, define the upper area of the line with the pre-configured substantially equal to the height for the area 402 or, if area 402 is not defined, a height equal to an average height of the characters string fields. In a case where no features are detected, define an area that is a predetermined distance adjacent (left or right) to a character string field having a height that is the average height of all retrieved character string fields. In one embodiment the area 402 has height such that the detected feature closest to a bottom of the image is included in the region. In a further embodiment, the upper and lower boundary of the area is dynamically determined based on image analysis of the suspected area such that the lower boundary can extend downward beyond the detected feature in the case where certain pixels in the candidate region indicate that the portion of the image may include handwritten information. This processing is illustrated in FIG. 4

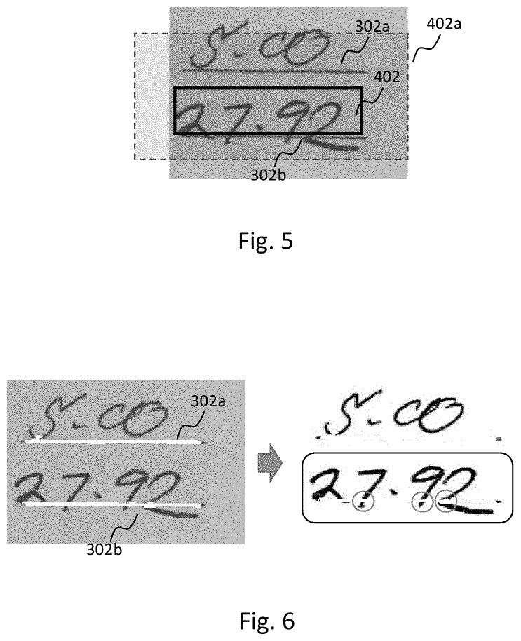

While the handwritten information is expected to be within region 402 as shown in FIGS. 3 and 4, it is not always case. In a case where handwritten information extends outside the region 402, the algorithm expands the region on which handwriting recognition processing is to be performed to make sure that the result of any such processing is accurate. The expansion of the boundary is illustrated in FIG. 5 and is part of step S112. From within the expanded boundary, the algorithm extracts data from the area of the image that corresponds to the detected features 302a and 302b and performs complement processing to recover any missing information lost due to the extraction processing thereby allowing the handwriting recognition processing to recognize the information within the expanded region as alphanumeric characters to be extracts.

As shown in FIG. 5, an expanded region 402a is defined so as to capture all relevant handwritten information and is shown within the dotted rectangle area. Upon defining the expanded area 402a, extraction processing is performed on the area of the image containing the horizontal line(s) which were identified by the emphasizing operation (and used to originally define area 402). This processing advantageously allows for correction of the handwritten text by due to any separation detected by the extraction of the lines. The result of this is shown in FIG. 6 whereby the features 302a and 302b have been removed and no longer show black pixels. Depending on the handwritten character condition, a numeric character may be broken into 2 parts unexpectedly by removing the horizontal line. In the sample case here, the numeric 7, 9, and 2 were broken into 2 parts such that a color of one or more pixels between each side is of a different (generally opposite) color. As can be seen from the area of FIG. 6 that is encircled, there are breaks (or gaps) in the handwritten information that, if not corrected as discussed below, would cause an error during handwriting recognition. As such, relevant complement processing is performed to correct the deficiencies resulting from extraction processing.

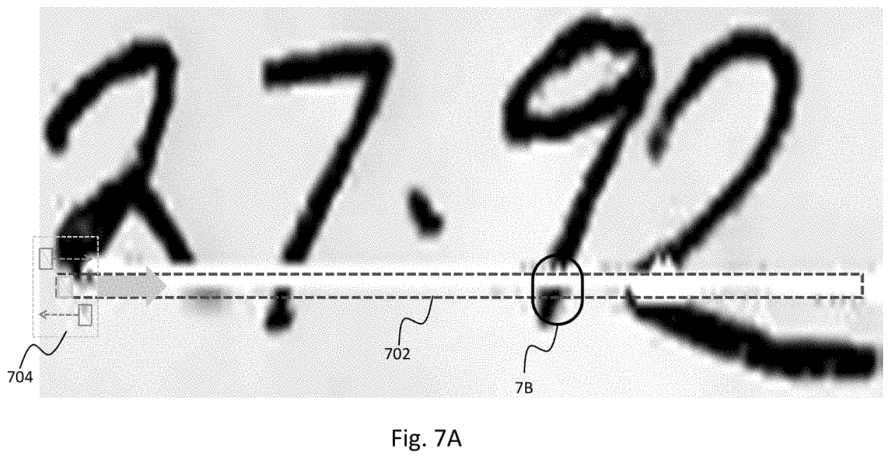

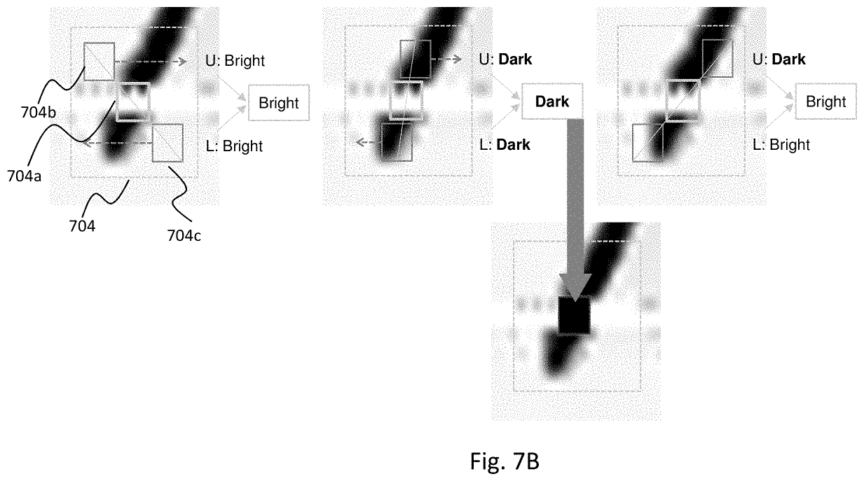

Complement processing to recover information is illustrated in FIGS. 7A and 7B. Initially, a correction region 702 (dotted line) corresponding to the extracted feature is set within the image. A size of the correction region 702 is substantially equal to a size of the feature that was removed from the image. A corrector 704 is used to traverse the area within the correction region 702 to determine if any image correction at a given position within the correction region 702 is needed. Correction processing occurs on each position of the removed horizontal line area within the correction region 702 and is performed by the corrector which shifts from one end of the correction region 702 to the other. In this embodiment, the correction processing proceeds from the left end of removed horizontal line to the right end in order to judge if the position was part of the numeric character before the horizontal line was removed.

FIG. 7B illustrates, in more detail, the corrector 704 and the operation performed at each position within the correction region 702 while the corrector traverses the image region. The corrector 704 is formed from at least three elements. A positioning element 704a has height substantially equal to a height of the correction region 702 and a predetermined width. In one embodiment the width is equal to or greater than one pixel. The positioning element 704 is preferably square in shape. A first analysis element 704b has a size substantially similar to the size of the positioning element 704 and is positioned at a top left corner of the positioning element 704 such that a bottom right corner of the first analysis element is adjacent to the top left corner of the positioning element 704. A second analysis element 704c which has the same shape and size of the first analysis element 704b is positioned at a bottom right corner of the positioning element 704 such that the top left corner of the second analysis element 704c is adjacent the bottom right corner of the positioning element 704c. Each element of the corrector 704a, 704b and 704c may cover a single pixel or a group of pixels so long as the size of each element is consistent. During correction processing, at a given position of the positioning element 704a, the first analysis element 702b traverses a top edge of the positioning element 704 in a first direction (e.g. a correction direction) while the second analysis element 704c traverses a bottom edge of the positioning element 704a. As the first and second analysis elements 704b and 704c move, each analysis element 704b and 704c analyze a pixel value (or, in the case where the size is a group of pixels covering a certain number of pixels, all pixel values of all pixels in the group) to obtain an average pixel value each square area above and below the positioning element 704a is calculated. In other words, the upper square (first analysis element 704b) shifts/scans from left to right and the lower square (second analysis element 704c) shifts/scans from right to left for pre-configured length. The correction processing judges that the target position over which the positioning element 704a is positioned is part of the original numeric character if, the analysis determines that the pixel value (or average pixel value) determined by the first and second analysis elements are below a pre-defined threshold value. If the pixel value (or average pixel values) are above the pre-defined threshold, then the correction processing judges that the target pixel is not part of the original numeric character. In other words, if the area either or both above and below the positioning element 704a has dark color, the positioning element 704a should be modified to be black color so as to complement the original numeric character(s). If the area either or both above and below the positioning element 704a has no color or a light color then the target pixel should remain white or have no additional color added thereto. The result of the complement processing of S112 is shown in FIG. 8 whereby the gaps from FIG. 6 are no filled in while also omitting the horizontal line which may interfere with handwriting recognition of the information. As long as each handwritten character is separated each other and no connection in writing stroke with other character(s), general handwriting recognition modules/processes can recognize each handwritten character.

In step S114, it is determined whether the corrected handwritten information contained in the expanded area 402a contains characters that are not adequately separate from one another. Without separation, the handwriting recognition processing may also not properly recognize the information. In other words, S114 includes performance of a secondary correction processing to remove or correct one or more other defect present within the recognition region. Secondary correction processing will be described with respect to FIGS. 9-10.

In FIG. 9, a first type of defect to be corrected by the secondary correction processing of S114 is when one or more characters are connected resulting in a judgement that one of the characters has a width much wider than its height and is therefore not proportionate. This is shown in FIG. 9 where the actual information is the number “33” but the second “3” is connected to a further mark (e.g. a horizontal line). Thus, recognition of this information would properly recognize the first “3” but would improperly recognize the second “3” due to its width extending into and beyond the first “3” due to the length of the mark. In this embodiment, a secondary performance of the complement processing can be performed whereby the mark can be extracted and corrected as discussed above. This is illustrated in the sequence shown in FIG. 9.

FIG. 10 illustrates a second type of defect where multiple characters are connected to one another. As shown herein, the information represents the number “50” but the “5” is connected to the “0” which would result in improper recognition because it would indicate that a character has an irregular size. In this instance, the secondary correction processing performs a histogram analysis of the image as shown in FIG. 10 and, at a location where there is a spike, separate the detected image into two separate images. In FIG. 10, there are only two elements that are connected and need to be split at the spike point as determined by a histogram analysis. However, this is illustrated for purposes of example only and any number of splits can occur depending on the height and width of the characters.

Based on the above processing a number of individual elements are able to be recognized as shown in FIG. 11. In step S116, a determination is made as to whether each recognized character is part of the Total Amount. In other words, are all characters part of the information to be extracted from the image. This determination is made by checking within region 402a all information detected therein to detect each handwritten character's height and location to define the mid position of its height. If the mid position is more than pre-configured distance from the mid position of the handwriting area illustrated by the line labeled 1102, then it is determined that the recognized information is not part of the Amount Value. As shown herein, the detected characters are “2”, “4”, “3” and “3”. The height of each of these characters is within the predetermined distance of the midline 1102 of region between the detected features. Also detected is a stray mark shown within the circle. However, the height is outside the pre-configured distance and is therefore judged not to be part of the information to be extracted.

Upon determining the correct information to be extracted, alphanumerical values corresponding to each extracted character can be provided and stored in a report while being associated with a particular recognized character string such as “Total Amount”. This resolves a problem associated with object recognition where all type written values are not the correct values to be extracted but instead, the correct value to be extracted is handwritten onto the object. Further, the algorithm described herein takes into account and corrects for the variation in handwriting techniques in order to accurately identify and extract the correct information from the image.

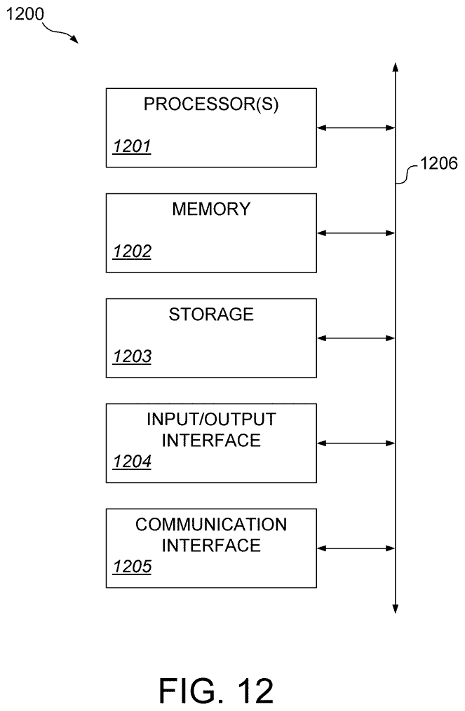

FIG. 12 illustrates the hardware components of an exemplary computing system that is configured to execute the recognition algorithm discussed above. The term computing device (or computing system) as used herein includes but is not limited to a hardware device that may include one or more software modules, one or more hardware modules, one or more firmware modules, or combinations thereof, that work together to perform operations on electronic data. The physical layout of the modules may vary. A computing device may include multiple computing devices coupled via a network. A computing device may include a single computing device where internal modules (such as a memory and processor) work together to perform operations on electronic data. Also, the term resource as used herein includes but is not limited to an object that can be processed at a computing device. A resource can be a portion of executable instructions or data.

In some embodiments, the computing device 1200 performs one or more steps of one or more methods described or illustrated herein. In some embodiments, the computing device 1200 provides functionality described or illustrated herein. In some embodiments, software running on the computing device 1200 performs one or more steps of one or more methods described or illustrated herein or provides functionality described or illustrated herein. Some embodiments include one or more portions of the computing device 1200.

The computing device 1200 includes one or more processor(s) 1201, memory 1202, storage 1203, an input/output (I/O) interface 1204, a communication interface 1205, and a bus 1206. The computing device 1200 may take any suitable physical form. For example, and not by way of limitation, the computing device 1200 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, PDA, a computing device, a tablet computer system, or a combination of two or more of these.

The processor(s) 1201 include hardware for executing instructions, such as those making up a computer program. The processor(s) 1201 may retrieve the instructions from the memory 1202, the storage 1203, an internal register, or an internal cache. The processor(s) 1201 then decode and execute the instructions. Then, the processor(s) 1201 write one or more results to the memory 1202, the storage 1203, the internal register, or the internal cache. The processor(s) 1201 may provide the processing capability to execute the operating system, programs, user and application interfaces, and any other functions of the computing device 1200.

The processor(s) 1201 may include a central processing unit (CPU), one or more general-purpose microprocessor(s), application-specific microprocessor(s), and/or special purpose microprocessor(s), or some combination of such processing components. The processor(s) 1201 may include one or more graphics processors, video processors, audio processors and/or related chip sets.

In some embodiments, the memory 1202 includes main memory for storing instructions for the processor(s) 1201 to execute or data for the processor(s) 1201 to operate on. By way of example, the computing device 1200 may load instructions from the storage 1203 or another source to the memory 1202. During or after execution of the instructions, the processor(s) 1201 may write one or more results (which may be intermediate or final results) to the memory 1202. One or more memory buses (which may each include an address bus and a data bus) may couple the processor(s) 1201 to the memory 1202. One or more memory management units (MMUs) may reside between the processor(s) 1201 and the memory 1202 and facilitate accesses to the memory 1202 requested by the processor(s) 1201. The memory 1202 may include one or more memories. The memory 1202 may be random access memory (RAM).

The storage 1203 stores data and/or instructions. As an example and not by way of limitation, the storage 1203 may include a hard disk drive, a floppy disk drive, flash memory, an optical disc, a magneto-optical disc, magnetic tape, or a Universal Serial Bus (USB) drive or a combination of two or more of these. In some embodiments, the storage 1203 is a removable medium. In some embodiments, the storage 1203 is a fixed medium. In some embodiments, the storage 1203 is internal to the computing device 1200. In some embodiments, the storage 1203 is external to the computing device 1200. In some embodiments, the storage 1203 is non-volatile, solid-state memory. In some embodiments, the storage 1203 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. The storage 1203 may include one or more memory devices. One or more program modules stored in the storage 1203 may be configured to cause various operations and processes described herein to be executed. While storage is shown as a single element, it should be noted that multiple storage devices of the same or different types may be included in the computing device 1200.

The I/O interface 1204 includes hardware, software, or both providing one or more interfaces for communication between the computing device 1200 and one or more I/O devices. The computing device 1200 may include one or more of these I/O devices, where appropriate. One or more of these I/O devices may enable communication between a person and the computing device 1200. As an example and not by way of limitation, an I/O device may include a keyboard, keypad, microphone, monitor, mouse, speaker, still camera, stylus, tablet, touch screen, trackball, video camera, another suitable I/O device or a combination of two or more of these. An I/O device may include one or more sensors. In some embodiments, the I/O interface 1204 includes one or more device or software drivers enabling the processor(s) 1201 to drive one or more of these I/O devices. The I/O interface 1204 may include one or more I/O interfaces.

The communication interface 1205 includes hardware, software, or both providing one or more interfaces for communication (such as, for example, packet-based communication) between the computing device 1200 and one or more other computing devices or one or more networks. As an example and not by way of limitation, the communication interface 1205 may include a network interface card (NIC) or a network controller for communicating with an Ethernet or other wire-based network or a wireless NIC (WNIC) or wireless adapter for communicating with a wireless network, such as a WI-FI network. This disclosure contemplates any suitable network and any suitable communication interface 1205 for it. As an example and not by way of limitation, the computing device 1200 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing device 1200 may communicate with a wireless PAN (WPAN) (such as, for example, a Bluetooth WPAN or an ultra wideband (UWB) network), a WI-FI network, a WI-MAX network, a cellular telephone network (such as, for example, a Global System for Mobile Communications (GSM) network), or other suitable wireless network or a combination of two or more of these. Additionally the communication interface may provide the functionality associated with short distance communication protocols such as NFC and thus may include an NFC identifier tag and/or an NFC reader able to read an NFC identifier tag positioned with a predetermined distance of the computing device. The computing device 1200 may include any suitable communication interface 1205 for any of these networks, where appropriate. The communication interface 1205 may include one or more communication interfaces 1205.

The bus 1206 interconnects various components of the computing device 1200 thereby enabling the transmission of data and execution of various processes. The bus 1206 may include one or more types of bus structures including a memory bus or memory controller, a peripheral bus, and a local bus using any of a variety of bus architectures.

The above description serves to explain the disclosure; but the invention should not be limited to the examples described above. For example, the order and/or timing of some of the various operations may vary from the examples given above without departing from the scope of the invention. Further by way of example, the type of network and/or computing devices may vary from the examples given above without departing from the scope of the invention. Other variations from the above-recited examples may also exist without departing from the scope of the disclosure.

The scope further includes a non-transitory computer-readable medium storing instructions that, when executed by one or more processors, cause the one or more processors to perform one or more embodiments described herein. Examples of a computer-readable medium include a hard disk, a floppy disk, a magneto-optical disk (MO), a compact-disk read-only memory (CD-ROM), a compact disk recordable (CD-R), a CD-Rewritable (CD-RW), a digital versatile disk ROM (DVD-ROM), a DVD-RAM, a DVD-RW, a DVD+RW, magnetic tape, a nonvolatile memory card, and a ROM. Computer-executable instructions can also be supplied to the computer-readable storage medium by being downloaded via a network.

While the present disclosure has been described with reference to exemplary embodiments, it is to be understood that the invention is not limited to the disclosed exemplary embodiments.

We claim:

1. An information processing method comprising:
identifying, from an image obtained via an image capture device, at least one character string that is relevant in identifying information to be extracted from the image; defining an area, within the image, that includes information as an information extraction area, the information including a plurality of information elements;
selecting a region within the defined area where the information to be extracted is expected to be present using a feature within the defined area;
removing the feature from the selected region and correcting one or more errors associated with the information caused by the removal of the feature;
extracting one or more alphanumeric characters from the corrected information, wherein the extracted one or more alphanumeric characters correspond to the elements of the information and are associated with a respective one of the at least one character strings.

2. The information processing method according to claim 1, wherein defining the area within the image as an information extraction area further comprises:
performing character recognition processing on the obtained image;
obtaining a plurality of character strings from within the obtained image including location information identifying a position of each of the plurality of character strings within the image;
using the location information identifying a position in the image for each of the obtained character strings identified as relevant to define the area within the image as the information extraction area.

3. The information processing method according to claim 2, further comprising:
determining a relative location of two or more character strings within the image; and
using the relative location of the two or more character strings to define the area within the image as the information extraction area.

4. The information processing method according to claim 1, wherein the feature within the defined area is associated with the at least one character string.

5. The information processing method according to claim 1, wherein removing the features causes a gap in at least one of the pieces of information preventing the one or more alphanumeric characters from being extracted.

6. The information processing method according to claim 5, wherein the correcting further comprises:
defining a correction region corresponding to the removed feature;
performing correction along an entire area of the correcting region in correction direction by
(a) analyzing, a current position within the correction region and along the correction direction, a brightness in an area above the correction region and an area below the correction region the current position; and
(b) correcting the current position within the correction region when the brightness is equal to or less than a threshold brightness by changing a color at the current position to a target color; and
moving along the correction direction to a new position and repeating (a) and (b) for each new position within the correction region.

7. The information processing method according to claim 1, further comprising:
determining that an element of information includes two or more element of information when a width of a first element is a first size and a width of a second element, adjacent to the first element, is a second size that overlaps the width of the first element; and
separating each of the two or more elements by removing a portion of the element that has a width equal to the width of the second element which overlaps the first element causing the elements to be extracted individually.

8. The information processing method according to claim 1, further comprising:
determining that an element of information includes two or more element of information when a width of the element exceeds a threshold expected width; and
performing a histogram analysis of the element and separating adjacent elements at a region corresponding to the peak of the histogram causing the elements to be extracted individually.

9. The information processing method wherein extracting the one or more alphanumeric characters further comprises:
determining a midline of the region in a horizontal direction;
measuring a height of each element of information and;
extracting, as respective alphanumeric characters, each element of information where a middle position of the respective element is within a predefined distance from the determined midline of the region; and
excluding any element where a middle position of the element is greater than the predefined distance.

10. An information processing apparatus comprising:
one or more memories storing instructions; and
one or more processors that execute the stored instructions and configure the one or more processors to:
identify, from an image obtained via an image capture device, at least one character string that is relevant in identifying information to be extracted from the image; define an area, within the image, that includes information as an information extraction area, the information including a plurality of information elements;
select a region within the defined area where the information to be extracted is expected to be present using a feature within the defined area;
remove the feature from the selected region and correcting one or more errors associated with the information caused by the removal of the feature;
extract one or more alphanumeric characters from the corrected information, wherein the extracted one or more alphanumeric characters correspond to the elements of the information and are associated with a respective one of the at least one character strings.

11. The information processing apparatus according to claim 10, wherein execution of the instructions further configures the one or more processors to,
perform character recognition processing on the obtained image;
obtain a plurality of character strings from within the obtained image including location information identifying a position of each of the plurality of character strings within the image;
use the location information identifying a position in the image for each of the obtained character strings identified as relevant to define the area within the image as the information extraction area.

12. The information processing apparatus according to claim 11, wherein execution of the instructions further configures the one or more processors to,
determine a relative location of two or more character strings within the image; and
use the relative location of the two or more character strings to define the area within the image as the information extraction area.

13. The information processing apparatus according to claim 10, wherein the feature within the defined area is associated with the at least one character string.

14. The information processing apparatus according to claim 10, wherein removing the features causes a gap in at least one of the pieces of information preventing the one or more alphanumeric characters from being extracted.

15. The information processing apparatus according to claim 14, wherein execution of the instructions further configures the one or more processors to,
define a correction region corresponding to the removed feature;
perform correction along an entire area of the correcting region in correction direction by
(a) analyzing, a current position within the correction region and along the correction direction, a brightness in an area above the correction region and an area below the correction region the current position; and
(b) correcting the current position within the correction region when the brightness is equal to or less than a threshold brightness by changing a color at the current position to a target color; and
move along the correction direction to a new position and repeating (a) and (b) for each new position within the correction region.

16. The information processing apparatus according to claim 10, wherein execution of the instructions further configures the one or more processors to,
determine that an element of information includes two or more element of information when a width of a first element is a first size and a width of a second element, adjacent to the first element, is a second size that overlaps the width of the first element; and
separate each of the two or more elements by removing a portion of the element that has a width equal to the width of the second element which overlaps the first element causing the elements to be extracted individually.

17. The information processing apparatus according to claim 10, wherein execution of the instructions further configures the one or more processors to,
determine that an element of information includes two or more element of information when a width of the element exceeds a threshold expected width; and
perform a histogram analysis of the element and separating adjacent elements at a region corresponding to the peak of the histogram causing the elements to be extracted individually.

18. The information processing apparatus according to claim 10, wherein execution of the instructions further configures the one or more processors to,
determine a midline of the region in a horizontal direction;
measure a height of each element of information and;
extract, as respective alphanumeric characters, each element of information where a middle position of the respective element is within a predefined distance from the determined midline of the region; and
exclude any element where a middle position of the element is greater than the predefined distance.
